(19) United States
(12) Patent Application Publication
(10) Pub. No.: US 2006/0103905 A1
(43) Pub. Date: May 18, 2006

(54) Multi spot optics in medical applications

(76) Inventor: Richard Walmsley, South Yarra (AU)

Correspondence Address: CALFEE HALTER & GRISWOLD, LLP, 800 SUPERIOR AVENUE, SUITE 1400, CLEVELAND, OH, 44114, US

(21) Appl. No.: 10/519,182

(22) PCT Filed: Jun. 25, 2003
(86) PCT No.: PCT/AU03/00790

§ 371 Date: Oct. 6, 2005

(30) Foreign Application Priority Data
Jun. 25, 2002 (AU) PS 3137

(51) Int. Cl. G02B 26/08

(52) U.S. Cl. 359/198

(57) ABSTRACT

A device is disclosed for generating a therapeutic photochemical effect to a treatment area. This device includes laser generating means (10) for generating a primary laser beam, multiple beam formation means (14) for forming at least two secondary laser beams from said primary beam for irradiating said treatment area. The multiple beam formation means (14) form the secondary beams by constructive and destructive interference. This device is suitable for treatment of conditions such as tendonitis, soft tissue injuries and lymphoedema.

### FIELD OF THE INVENTION

This invention relates to therapeutic medical application of laser radiation to the human body.

### BACKGROUND OF THE INVENTION

It is known to apply laser radiation to the human body for a number of diverse therapeutic and medicative purposes. One example is the use of relatively high power lasers to ablate tissue either internal or external of the human body such as the application of relatively high powered lasers for the sculpting of the corneal surface to correct myopia. Another, important therapeutic application of laser technology is the use of low power lasers to effect photochemical reactions (non-heating) for the treatment of pain, soft tissue injuries, healing of wounds and furthermore the treatment of lymphoedema.

For this type of low level laser therapy the frequency, power level (continuously on or modulated on/off duty cycle of the radiation at the same or changing levels) and characteristics of the laser are determined by the nature of the treatment outcome desired by a clinician. As relatively low power lasers are employed, it is typical to apply the laser radiation by using a hand held device under the control of the clinician or an appropriately trained operator. The laser characteristics are programmed or preset and inherent in all laser devices safety procedures are recommended and complied with.

The treatment area requiring effective laser irradiation is determined by the required treatment outcome. In many instances, application of the laser to a number of distinct regions regularly spaced in a treatment area is required to deliver an overall therapeutic benefit. The low power laser devices employed to generate the photochemical reaction typically only generate a beam which effectively covers a region in the order of one cm². Thus the operator must manually reposition the laser to treat each of the distinct regions within a treatment area. Clearly this method is somewhat haphazard as a clinician must rely on their judgment to ensure that the entire treatment area is being uniformly irradiated both in terms of intensity and duration.

One attempt to address this significant problem is by the use of “scanning” technology whereby a moveable mirror is introduced into the optical path of the laser emitting device to change the direction of the beam in a continuous manner thus covering the desired treatment area. This approach has a number of disadvantages. Firstly, this type of “scanning” probe is a more complex device involving moving parts and as a consequence is not suitable to be hand held. Secondly, in many photochemical effect type applications, it is advantageous to treat a distinct region for a predetermined amount of time before moving to the next region in the treatment area. As a scanning probe continuously traverses the treatment area, no distinct region within the treatment area will receive radiation for a significant block of time.

To address this disadvantage “cluster” type probe have been developed. These devices include multiple laser diodes enclosed in a single instrument head thereby using separate laser devices to simultaneously irradiate the individual distinct regions within a treatment area. However, this type of device is bulky and the inherent complexity of powering multiple laser emitting devices at the level required for treatment makes these devices both expensive and difficult to maintain.

Therefore, it is an aim of the invention disclosed herein to provide an alternative to the above-described methods of laser radiation application which effect a therapeutic photochemical reaction by providing a device heretofore unknown to the inventor.

### SUMMARY OF THE INVENTION

In a first aspect the present invention accordingly provides a device for generating a therapeutic photochemical effect to a treatment area, said device including:
laser generating means for generating a primary laser beam;
multiple beam formation means for forming at least two secondary laser beams from said primary beam for irradiating said treatment area;
wherein multiple beam formation means form said secondary beams by constructive and destructive interference.

Preferably the secondary beams are formed having predetermined spacing between said beams.

Preferably the secondary beams are formed having predetermined individual intensities.

Preferably the secondary beams are formed having predetermined individual spot sizes and distributions.

Preferably the multiple beam formation means includes a diffractive element.

Optionally the multiple beam formation means includes a holographic element.

Preferably the device further includes positioning means for positioning said device at a predetermined distance and orientation from said treatment area.

In a second aspect the present invention accordingly provides a method for irradiating a treatment area to generate a therapeutic photochemical effect, said method including the steps of:
forming at least two secondary laser beams from a first primary beam by constructive and destructive interference;
positioning said secondary beams at a predetermined distance and orientation relative to said treatment area;
irradiating said treatment area with said secondary beams for a predetermined time.

### BRIEF DESCRIPTION OF FIGURES

Specific embodiments of the invention will now be described in some further detail with reference to and as illustrated in the accompanying figures. These embodiments are illustrative, and not meant to be restrictive of the scope of the invention. Suggestions and descriptions of other embodiments may be included within the scope of the invention but they may not be illustrated in the accompanying figures or alternatively features of the invention may be shown in the figures but not described in the specification.

FIG. 1 depicts a diffractive optical element located at the output of a laser emission device and shows a multi beam output following the diffractive optical element;

FIG. 2 depicts a spot pattern generated by the device of FIG. 1;

FIG. 3 depicts a pictorial representation of an array of spot patterns created on a tissue using a single beam laser emission device; and

FIG. 4 depicts use of a preferred embodiment of the invention for the treatment of lymphoedema.

### DETAILED DESCRIPTION OF A PREFERRED EMBODIMENT OF THE INVENTION

Although a particular medical application is described herein and a particular laser emitting device configuration is also described, it should be understood that these details are illustrative only and not meant to be limiting in any way upon the application or configuration of the invention.

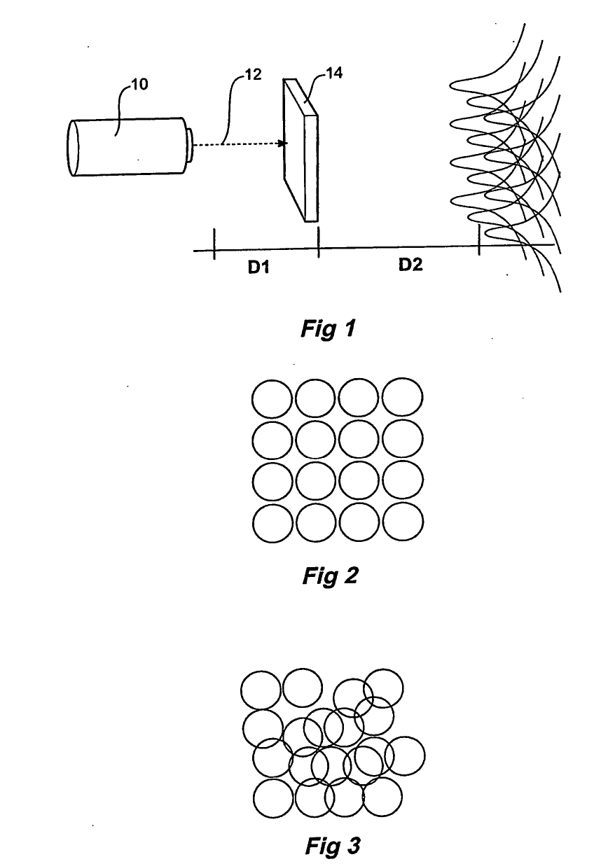

FIG. 1 depicts a pictorial representation of a device according to the invention having a laser emission device 10 that shows a single beam of laser radiation 12.

Laser radiation 12 although not depicted in detail, may have a number of characteristics such as a predetermined spot size, power, frequency/wavelength and modulation. In a practical application the single beam may be designed to have characteristics suitable for the treatment of lymphoedema. When treating lymphoedema there exist predetermined laser radiation protocols that, in one example, requires that the single spot beam be applied to the appropriate gland site (e.g. armpit) and any associated areas of tissue hardness. Also the single spot beam may be applied to surgical scars. Such scars may result from a surgical procedure conducted prior to the need to treat the lymphoedema. For example the conduct of a mastectomy often is the precursor for lymphoedema in patients.

In each of these cases, irradiation of a relatively large treatment area is required so clearly the treatment process is a laborious and time-consuming process for both the clinician and the patient, as the single spot beam must be applied to multiple distinct regions within the treatment area.

It is proposed that by locating a specially designed diffractive optical element 14 (seen in pictorial form a distance D1 from the output of the laser device 10) a multitude of individual laser beams be created. Whilst in this preferred embodiment a diffractive transmission grating is employed other optical elements which are capable of forming multiple secondary beams by constructive and destructive interference are contemplated to be within the scope of the present invention. Each of these beams in turn forms a laser radiation spot on or about the area of tissue to be treated, which in one example is the armpit of the patient. In FIG. 1, the treatment area is depicted at being a distance D2 from the diffractive optical element 14.

Thus the output of a laser device 10 having a predetermined emitting aperture and divergence 12 passes through a diffractive optical element 14 to make the apparent aperture of the device appear much larger. The distance D1 of the diffractive optical element from the laser aperture and the predetermined divergence of the laser determines the distribution of the laser light over the patient.

As is readily apparent, a treatment using the multi-beam laser-emitting device in this example consists of a one step process. The time for delivery of the treatment is clearly much shorter and likely more accurate than the prior process.

As will be discussed other optical elements can be included in the apparatus such as focussing optics to make each of the multiple spots have particular size etc. In experimental apparatus the laser diode used is highly divergent. If that apparatus were required to deliver 17 laser spot treatments over a given area and time, the apparatus would need to be held off the tissue of the patient by some distance to keep the spot size of the laser the same as if it were in contact mode. It is possible to use some lenses prior to or even after the multi-spot optics proposed in this disclosure.

It is also conceivable to use a higher-powered laser to reduce the treatment time. In which case it might be useful to also use a device known as a homogeniser to keep the whole apparatus within Class I limitations. This is one alternative but there are other applications where Class I limitations are not required or warranted.

The spread and characteristics of the array of beams emitted by the laser device can be defined and controlled at the time of manufacture of the device. In particular a specially designed diffractive optical element splits the single laser beam into two or more beams. Those beams do not have to be circular when they land on the skin surface but could be arranged to be a set of lines or ellipses, or other shapes in an appropriate configuration. The distribution of the power of the beams/lines can also vary. The above performance criteria of a suitable diffractive optical element can be specified to Rochester Photonics, Limo or Diffractive Optics Corporation who can produce a diffractive optical element to order.

In the illustrated embodiment the multiple beams are arranged especially to create a predetermined beam configuration and characteristic. The manufacturing process of the diffractive optical element determines that the multiple beams are each of the same power distribution or that they may have a distribution that ranges from, a graduated radial distribution to homogenous over its area. It is also possible for the manufactured diffractive optical element to provide multi beam arrays that have an even spread or that cluster in some predetermined way.

FIG. 2 is an example of the spot pattern generated by a diffractive optical element wherein each beam has a graduated power distribution and resultant spots that are evenly spread over a predetermined area.

When using a diffractive optical element it may be necessary to use a higher laser power at the source 10 to ensure that each of the multiple beams have the requisite power to effect the desired diagnostic or therapeutic outcome.

Furthermore, the spacing of the diffractive optical element from the patient will need to be gauged so as to ensure the desired radiation level and area of coverage is achieved on the skin or organ to be irradiated. The means of gauging that distance are many and varied.

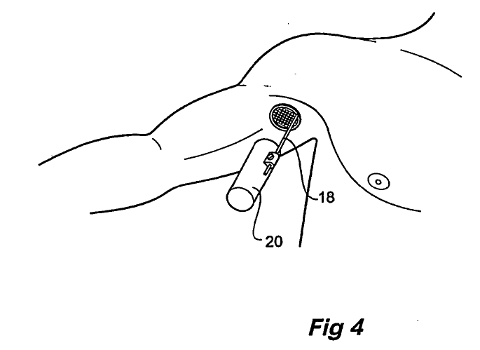

Referring to FIG. 4, in one embodiment suitable for the treatment of lymphoedema, the gauge may comprise a plastic or metal frame 18 that has an abutment surface that is positioned on the treatment area to be irradiated whilst the other end is fixed relative to the optical element or the structure that positions it from the source laser output. Accordingly, frame 18 is adjustably attached to the treatment device 20 which incorporates the laser device 10 and diffractive optical element 14. Frame 18 can be disposable for those procedures which require a different or new sterile apparatus for each use of the device so as to prevent cross contamination. This may be an issue when some patients will suffer related or sometimes unrelated skin disorders, such as ulcers or non-healing pressure sores.

Clearly, frame 18 can be modified to accommodate application treatment differences where for example the treatment area to be treated varies between large and small or is located in an awkward to get to area of the body.

In another embodiment the laser output is provided to the diffractive optical element via an optical fiber or like functioning laser energy conduit (not shown).

The size and power of the one or more lasers illuminating the diffractive optical element may or may not be the same and as such the one or more of the multiple laser beams being output from it will vary as required

FIG. 3 is used to crudely illustrate the spot pattern that could be created by a clinician using a single beam laser radiating device and it is illustrative to note the inconsistency of the distribution that results in some areas being irradiated twice and other areas missing out completely.

Contrast the irradiation result pictorially represented in FIG. 3 with the radiation result depicted in FIG. 2 showing a uniform distribution of laser beam spot energy. Combine that with the speed with which the radiation is applied by a single application of radiation by a clinician using the device according to the present invention and the benefits are readily apparent. In addition treatment protocols are more readily complied with resulting in improved treatment outcomes in comparison to the use of prior art treatment delivery means and methods.

Indications are that the simultaneous application of laser radiation in the case of lymphoedema treatment has the same effect, if not a marginally better effect than when a single laser beam emission device is used by a trained operator.

It will be appreciated by those skilled in the art that the invention is not restricted in its use to the particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications within its scope.

1. A device for generating a therapeutic photochemical effect to a treatment area, said device including:
laser generating means for generating a primary laser beam;
multiple beam formation means for forming at least two secondary laser beams from said primary beam for irradiating said treatment area;
wherein multiple beam formation means form said secondary beams by constructive and destructive interference.

2. A device as claimed in claim 1, wherein said secondary beams are formed having predetermined spacing between said beams.

3. A device as claimed in claim 1, wherein said secondary beams are formed having predetermined individual intensities.

4. A device as claimed in claim 1, wherein said secondary beams are formed having predetermined individual spot sizes and distributions.

5. A device as claimed in claim 1, wherein said multiple beam formation means includes a diffractive element.

6. A device as claimed in claim 5, wherein said diffractive element is a reflection grating.

7. A device as claimed in claim 5, wherein said diffractive element is a transmission grating.

8. A device as claimed in claim 1, wherein said multiple beam formation means includes a holographic element.

9. a device as claimed in claim 1, wherein said therapeutic photographic effect is generated for the treatment of lymphoedema.

10. A device as claimed in claim 1, further including a positioning means for positioning said device as a predetermined distance and orientation from said treatment area.

11. A device as claimed in claim 10, wherein said positioning means includes a frame, said frame adjustably attached to said device and when in use provides an abutment surface relative to said treatment area.

12. A multiple beam formation element for inclusion in the device claimed in claim 1.

13. A method for irradiating a treatment area to generate a therapeutic photochemical effect, said method including the steps of:
forming at least two secondary laser beams from a first primary beam by constructive and destructive interference;
positioning said secondary beams at a predetermined distance and orientation relative to said treatment area;
irradiating said treatment area with said secondary beams for a predetermined time.

14. A method as claimed in claim 13, wherein said therapeutic photochemical effect is generated for the treatment of lymphoedema.

15-16. (canceled)
